(19) United States
(12) Patent Application Publication
(10) Pub. No.: US 2001/0030694 A1
(43) Pub. Date: Oct. 18, 2001

(54) Digital still camera performing white balance adjustment

(75) Inventor: Tetsuya Abe, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 09/802,955

(22) Filed: Mar. 12, 2001

(30) Foreign Application Priority Data
Mar. 15, 2000 (JP) P2000-071776

(51) Int. Cl. H04N 5/225

(52) U.S. Cl. 348/223; 348/655; 348/220

(57) ABSTRACT

a digital still camera with an image sensor exposes the image sensor to capture a series of still images. The signal processor generates a series of one frame worth of color image signals. The color temperature setter defines a standard color temperature corresponding to the illuminating-light, and defines at least one shifted color temperature, which is different relative to the standard color temperature by a given amount. The color balance adjuster that adjusts a relative color balance with respect to red, green and blue color signal components in each of the series of one frame worth of color image signals, in accordance with the standard color temperature and the shifted color temperature. At this time, the color balance adjuster adjusts the relative color balance, by changing the color temperature in each of the series of one frame worth of color image signals.

### BACKGROUND OF THE INVENTION

1. Field of the Invention

The present invention relates to a digital still camera with a white-balance adjustment function.

2. Description of the Related Art

A digital still camera has an image sensor, such as a CCD (Charge-Coupled Device). When light from an illuminating light source reflects from an object, an object image is formed on the image sensor. Image-pixel signals, generated in the image sensor, are read from the image sensor, and then one frame worth of color image signals, composed of red (R) color signal component, green (G) color signal component and blue (B) color signal component, are generated.

As is well known, color balance of the R, G and B color signal components varies with the type of illuminating-light, such as fluorescent light, daylight, etc. In consequence, the color-reproduction characteristic in the recorded still image may be degraded when subjected to specific illuminating-light. In other words, the reproduced color in the recorded still image, obtained on the basis of the color image signals, is different from the color of the object as perceived by an observer. To solve the above problem, the digital still camera has a white-balance adjustment function, which adjusts the relative color balance of the color image signals in accordance with the color temperature of the illuminating-light.

A recent digital still camera can perform an AWB (Auto White Balance) adjustment and a MSWB (Manual Selecting White Balance) adjustment. In the case of the AWB adjustment, a gain of the red color signal component and a gain of the blue color signal component are adjusted such that an output ratio of the R, G and B color signal components becomes “1:1:1” when the object is a white-object. On the other hand, in the case of the MSWB adjustment, a user selects a color temperature corresponding to the present illuminating-light, from a plurality of color temperatures preset in advance. By using the AWB or MSWB adjustment function, color in the recorded still image is corrected.

However, when the object is a specific object, such as blue-sky, blue-sea, etc., or the color temperature is not precisely detected or is improperly set by the operator, the color is not reproduced properly. Further, the color in the recorded image does not necessarily become a color, which the user prefers.

On the other hand, when performing an image process to adjust color in the recorded image using a personal computer, the image-processing becomes troublesome and picture quality is degraded by the image-process.

### SUMMARY OF THE INVENTION

Therefore, an object of the present invention is to provide a digital still camera capable of recording an object image, in which the color is the color that the user prefers.

According to the present invention, a digital still camera with an image sensor has an exposure controller, a signal processor, a color temperature setter, a color balance adjuster and a recording processor. The exposure controller exposes the image sensor such that a series of still images is consecutively captured. Thus, a series of one frame worth of image-pixel signals, corresponding to the series of still images, are read from the image sensor in order. The signal processor generates a series of one frame worth of color image signals in accordance with the series of one frame worth of image-pixel signals. Each color image signals are divided into a red color signal component, a green color signal component and a blue color signal component respectively. The color temperature setter defines a standard color temperature corresponding to the illuminating-light, and defines at least one shifted color temperature, which is different relative to the standard color temperature by a given amount. The color balance adjuster adjusts the relative color balance with respect to the red, green and blue color signal components in each of the series of one frame worth of color image signals, in accordance with the standard color temperature and the shifted color temperatures. The recording processor records at least one of the series of one frame worth of color image signals, adjusted with respect to the relative color balance, in a recording medium detachably installed in the digital still camera. Then, the color balance adjuster adjusts the relative color balance, by changing the color temperature in each of the series of one frame worth of color image signals.

According to another aspect of the present invention, a white balance adjustment apparatus incorporated in a digital still camera with an image sensor, has a color temperature setter and a color balance adjuster. Note that, a series of one frame worth of color image signals is generated on the basis of a series of one frame worth of image-pixel signals read from the image sensor in order. The color temperature setter defines a standard color temperature corresponding to the illuminating-light, and defines at least one shifted color temperature, which is different relative to the standard color temperature by a given amount. The color balance adjuster adjusts the relative color balance with respect to red, green and blue color signal components in each of the series of one frame worth of color image signals, in accordance with the standard color temperature and shifted color temperatures. Then, the color balance adjuster adjusts the relative color balance, by changing the color temperature in each of the series of one frame worth of color image signals.

### BRIEF DESCRIPTION OF THE DRAWINGS

The present invention will be better understood from the description of the preferred embodiment of the invention set forth below together with the accompanying drawings, in which:

FIG. 1 is a perspective view of a digital still camera of an embodiment seen from the front.

FIG. 2 is a perspective view of the digital still camera seen from the back.

FIG. 3 is a block diagram of the digital still camera.

FIG. 4 is a view showing a color temperature represented by a reciprocal of correlated color temperature and gain coefficients.

FIG. 5 is a flowchart showing a photographing process.

FIG. 6A and 6B are flowcharts showing a subroutine of Step 520, indicating a photographing process with a “WB bracketing mode”, shown in FIG. 5

FIG. 7 is a flowchart showing a subroutine of Step 600, indicating a recording process with a “frame-mode”, shown in FIG. 6B.

FIG. 8 is a flowchart showing a subroutine of Step 700, indicating a recording process with a “thumbnails-mode”, shown in FIG. 6B.

### DESCRIPTION OF THE PREFERRED EMBODIMENTS

Hereinafter, the preferred embodiment of the present invention is described with reference to the attached drawings.

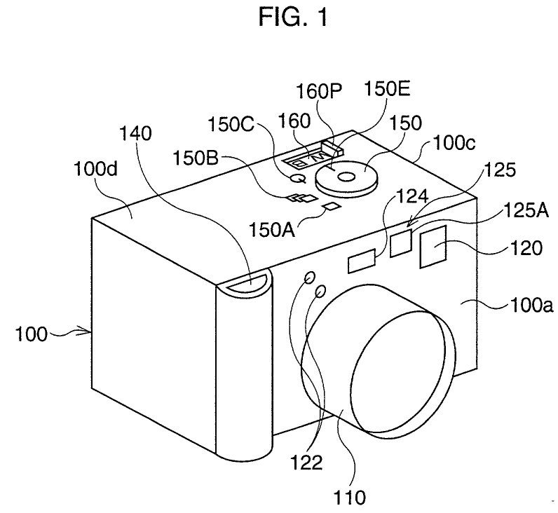

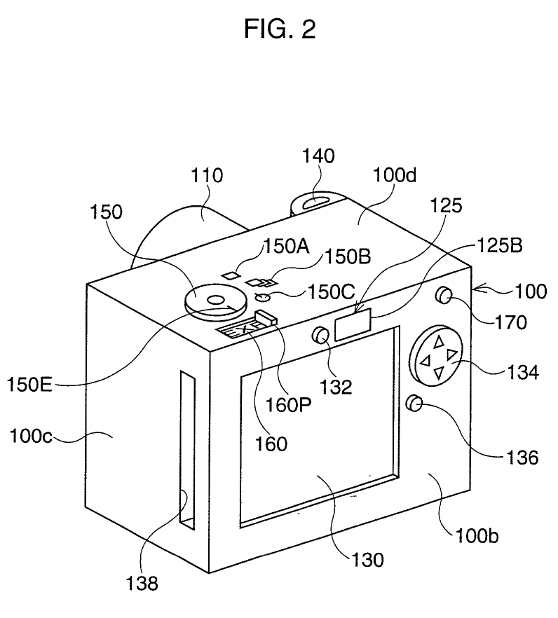

FIGS. 1 and 2 are perspective views of a digital still camera of an embodiment of the present invention. FIG. 1 is the perspective view seen from the front, and FIG. 2 is the perspective view seen from the back.

A digital still camera 100 has a lens barrel 110 with a photographing optical system and an image sensor (not shown here), the lens barrel 110 is mounted to a front surface 100a. A color temperature sensor 120, a distance-metering sensor 122 and a photometry sensor 124 are provided on the front surface 100a. In this embodiment, the color temperature sensor 120 has a red photo diode with a red color filter, a green photo diode with a green color filter and a blue photodiode with a blue color filter. In accordance with the ratio of R-signals, G-signals and B-signals, read from the red, green and blue photodiodes respectively, the color temperature of the illuminating-light is detected.

On the back surface 100b of the digital still camera 100, an LCD (Liquid Crystal Display) 130 is provided, further, a power button 132, a cross button 134 for selecting a menu or an object image displayed on the LCD 130 and a cancel button 136 are provided near the LCD 130. At the side surface 100c of the digital still camera 100, a card slot 138 for installing a memory card (not shown here), such as a flash memory, is formed.

On the upper surface 100d of the digital still camera 100, a release button 140, a mode-selection dial 150 and a WB/EXP bracketing selecting-lever 160 are provided. An index 150E is marked on the Mode-selection dial 150, and further graphical symbols 150A, 150B, 150C are marked around the mode-selection dial 150, on the upper surface 100d. The mode-selection dial 150 is rotated by the operator, and the photographing mode is set in accordance with the rotational position of the index 150E. Namely, the photographing mode is determined by the position of the index 150E. When the index 150E aligns with the symbol 150A, a “one-shot photographing mode” for capturing one frame, is selected. When the index 150E aligns with the symbol 150B, a “continuous photographing mode” for capturing a plurality of frames is selected. When the index 150E aligns with the symbol 150C, a “timer photographing mode” for photographing by using a timer function is selected.

When the index 150E aligns with the WB/EXP bracketing selecting-lever 160, which is a slide lever, a “WB (White Balance) bracketing mode” or an “EXP (Exposure) bracketing mode” is selected. In accordance with the position of the WB/EXP bracketing selecting-lever 160, a mode is selected from either the “WB bracketing mode” or the “EXP bracketing mode”. When the knob portion 160P of the WB/WXP bracketing selecting-lever 160 is positioned at the side of the surface 100c and the letter “WB” is shown, as shown in FIG. 1, the “WB bracketing mode” is set. In this embodiment, by depressing the release button 140 fully, three-frames of object images are captured with different the white balance adjustments, as described later. On the other hand, when the knob 160P is positioned at the opposite side and the letter “EXP” is shown, as shown in FIG. 2, the “EXP bracketing mode” is set. By depressing the release button 140 fully, three-frames of object images are captured with different an exposure values.

The digital still camera has a viewfinder 125 including an objective lens 125A provided at the front surface 100a and an eyepiece 125B provided at the back surface 100b, as shown in FIGS. 1 and 2. The operator observes the object image via the viewfinder 125.

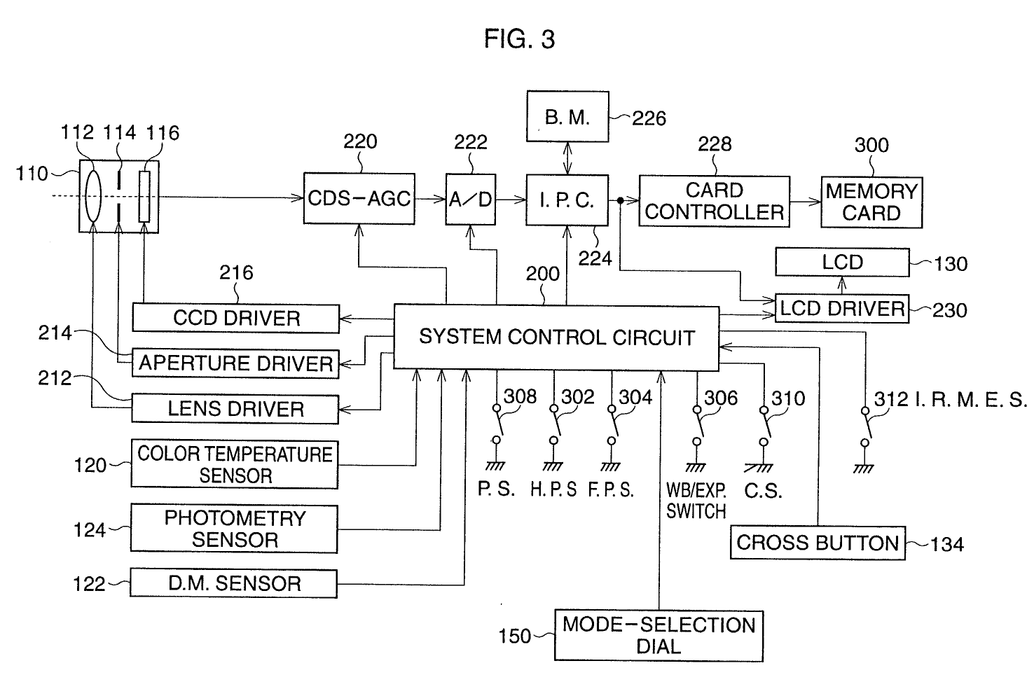

FIG. 3 is a block diagram of the digital still camera. A system control circuit 200 controls the entire digital still camera 100.

In the lens barrel 110, an aperture 114 and a photographing optical system 112 with a focusing lens are provided. The digital still camera 100 has an AF (Auto Focus) control function. A distance between the camera 100 and the object is measured by the distance-metering sensor 122, and the focusing lens is driven by a lens driver 212 to focus the object image. The digital still camera also has an AE (Auto Exposure) function. Brightness of an object is measured by the photometry sensor 124, and the aperture 114 is controlled in accordance with the resulting measurement.

The object image is formed on a CCD 116, which is an image sensor, by light passing through the photographing optical system 112 and the aperture 114. Namely, the CCD 116 is exposed (irradiated) for a preset exposure period. In this embodiment, an “electronic shutter”, well known in the prior art, is used to adjust the exposure period. On the CCD 116, a color filter (not shown), checkered by Red (R) color, Green (G) color and Blue (B) colors, is provided. In the CCD 116, analog image-pixel signals of one frame worth, corresponding to the object image, are generated and fed to a CDS (Correlated Double Sampling)-AGC (Auto Gain Control) circuit 220 after the exposure period has passed. The CCD 116 is driven by a CCD driver 216, the image-pixel signals being output in accordance with a pulse signal fed from the CCD driver 216.

In the CDS-AGC circuit 220, noise included in the image-pixel signals is removed and again control is performed to maintain the signal output level of the image-pixel signals. Note that, the gain control performed in the CDS-AGC circuit 220 is different from a gain adjustment performed during a white balance adjustment described later.

The analog image-pixel signals output from the CDS-AGC circuit 220 are converted to digital color image signals in an A/D converter 222, and then fed to an image processing circuit 224.

In the image processing circuit 224, the digital image signals are divided into a red (R) color signal component corresponding to the color red, a green (G) color signal component corresponding to the color green and a blue (B) color signal component corresponding to the color blue. Then, various processes, including a white balance adjustment process, gamma correction process, are performed to the divided digital color image signals. The processed digital image signals are then temporarily stored in a buffer memory 226.

When displaying one object image on the LCD 130, the one frame worth of digital color image signals is read from the buffer memory 226 and fed to a LCD driver 230. The LCD driver 230 drives the LCD 130 in accordance with the fed digital image signals, whereby the object image is displayed on the LCD 130. An image-reproduction mode button 170, provided at the back surface 100b, is operated to set the image-reproduction mode to a “frame-mode” or a “thumbnails-mode”, as described later.

When recording an object image, the digital color image signals are read from the buffer memory 226 and are then subjected to a compression process in accordance with a predetermined compression method, such as a JPEG method, in the image processing circuit 224. The compressed digital image signals are recorded as image data via a card controller 228 in a memory card 300, which is installed in the card slot 138 (See FIG. 2). When expanding the compressed image data, the image data is read from the memory card 300 via the card controller 228 and is then subjected to an expansion process in the image processing circuit 224.

The digital still camera 100 has an AWB adjustment function. The color temperature of light illuminating the object is measured by the color temperature sensor 120 and the white balance adjustment is automatically performed to the color digital image signals, which are divided into R, G, B color signal components, in accordance with the detected color temperature. The AWB adjustment is selected and canceled by operating the cross button 134, as required.

When the AWB adjustment is not performed, namely, the MSWB adjustment is selected by the cross button 134, the color temperature is preset by the operator. A plurality of color temperatures corresponding to various types of illuminating-light, such as daylight, fluorescent light and so on, are prepared in advance, and the operator selects a color temperature, which is suitable for the present photographing condition, from the plurality of color temperatures. Then, the white balance adjustment is performed in accordance with the selected color temperature. In this embodiment, daylight, fluorescent light, incandescent light, clouded-light are considered, and color temperatures corresponding to the series of illuminating-light are stored in a memory (not shown) in the system control circuit 200 as data. The operator selects a proper color temperature, corresponding to the illuminating-light of the photographing condition, by operating the cross button 134.

A half-push switch 302, a full-push switch 304, the mode-selection dial 150 and a WB/EXP switch 306 are connected to the system control circuit 200. When the release button 140 is halfway depressed, the half-push switch 302 is turned ON, and when the release button 140 is fully depressed, the full-push switch 304 is turned ON. The WB/EXP switch 306 is turned ON and OFF in accordance with the position of the WB/EXP bracketing selecting-lever 160. Further, a power switch 308, a cancel switch 310, an image-reproduction mode switch 312 corresponding to the image-reproduction mode button 170 and the cross button 134 are connected to the system control circuit 200. The power switch 308 is turned ON when the power button 132 is depressed, and the cancel switch 310 is turned ON when the cancel button 136 is depressed.

When the release button 140 is halfway depressed to capture an image, focusing is automatically performed and the exposure value, including an exposure period and an aperture value is obtained. At this time, when the AWB adjustment is selected, the color temperature is detected. Further, when the release button 140 is depressed fully, the photographing or capturing, is performed in accordance with the photographing mode, which is defined by the position of the mode-selection dial 150 and WB/EXP bracketing selecting-lever 160. Thus, a series of photographing processes are performed.

When the “WB bracketing mode” is selected by the mode-selection dial 150 and the WB/EXP bracketing selecting-lever as shown in FIG. 1, three frame worth of object images are consecutively captured at given time intervals. Consequently, as described later, three frame worth of image-pixels signals are read from the CCD 116 in order, each of which is different with respect to the white balance adjustment, and stored in the buffer memory 226.

With respect to the first frame among the three frames, the white balance adjustment is performed in accordance with a color temperature that corresponds to the illuminating-light, which is automatically or manually set. Hereinafter, the above selected color temperature is represented by a standard color temperature Gr.

The system control circuit 200 has a gain-coefficient memory (not shown), in which a relationship between the standard color temperature Gr and R-gain and B-gain coefficients α, β, corresponding to the R-color (red color) signal component and the B-color (blue color) signal component respectively, are stored as data. When the standard color temperature Gr is determined automatically or manually, the R-gain and B-gain coefficients α, β, corresponding to the standard color temperature Gr, are obtained in accordance with the relationship. The R-gain coefficient α and the B-gain coefficient β are then multiplied by the R-color signal component and the B-color signal component respectively, at the image processing circuit 224.

The R-gain and B-gain coefficients α, β are defined such that the ratio of the R-color signal component, G-color (green color) signal component and B-color signal component becomes “1:1:1” when an object is a white-object. Therefore, when the white-object is photographed by the digital still camera 100, the following formula is satisfied:

Eg=α×Er=βEb (1)

Note that, the values of the R-color signal component, G-color signal component and B-color signal component, which are output from the image processing circuit 224, are represented by “Er”, “Eg” and “Eb”, respectively.

As is well known, usually, a color temperature is represented by a correlated color temperature (unit: K), further represented by an inverse, or reciprocal, of the correlated color temperature (unit: MK (Mega Kelvin)⁻¹). By representing the color temperature by the reciprocal of the correlated color temperature, the relationship between the color temperature and the R-gain and B-gain coefficients α, β substantially becomes linear. Hereinafter, the color temperature is represented by the reciprocal of the correlated color temperature.

With respect to the second frame among three frames, a first shifted color temperature Gu, which is larger than the standard color temperature Gr by a predetermined amount, is defined. Note that, the predetermined amount is represented by the reciprocal of the correlated color temperature. In this embodiment, the first shift color temperature Gu is larger than the standard color temperature Gr by 10 (MK⁻¹). In this case, R-gain and B-gain coefficients α′, β′, corresponding to the first shifted color temperature Gu, are defined by utilizing the above relationship. The obtained R-gain ad B-gain coefficients α′, α′ are multiplied by the R-signal component and B-signal component respectively.

With respect to the third frame among the three frames, a second shifted color temperature Gd is smaller than the standard color temperature Gr by a predetermined amount. In this embodiment, the second shifted color temperature Gd is smaller than the standard color temperature Gr by 10 (MK⁻¹). Then, gain coefficients α″, β″, corresponding to the second shifted color temperature Gd, are defined by utilizing the relationship. The obtained R-gain ad B-gain coefficients α″, β″ are multiplied by the R-signal component and B-signal component respectively.

After the photographing process is performed, three frame images are displayed on the LCD monitor 130 in accordance with the “thumbnails mode” or the “frame-mode”. When the “thumbnails-mode” is selected, three frame images are displayed on the LCD 130 simultaneously and on the other hand, when the “frame-mode” is selected, the three frames are selectively displayed frame by frame. The “thumbnails-mode” and the “frame-mode” are interchanged by depressing the image reproduction mode button 170, namely, switching ON or OFF the image reproduction mode exchanging switch 312. To record the captured images in the memory card 300, the release button 140 is fully depressed, thus the object image, selected by the operator, is recorded in the memory card 300, as described later.

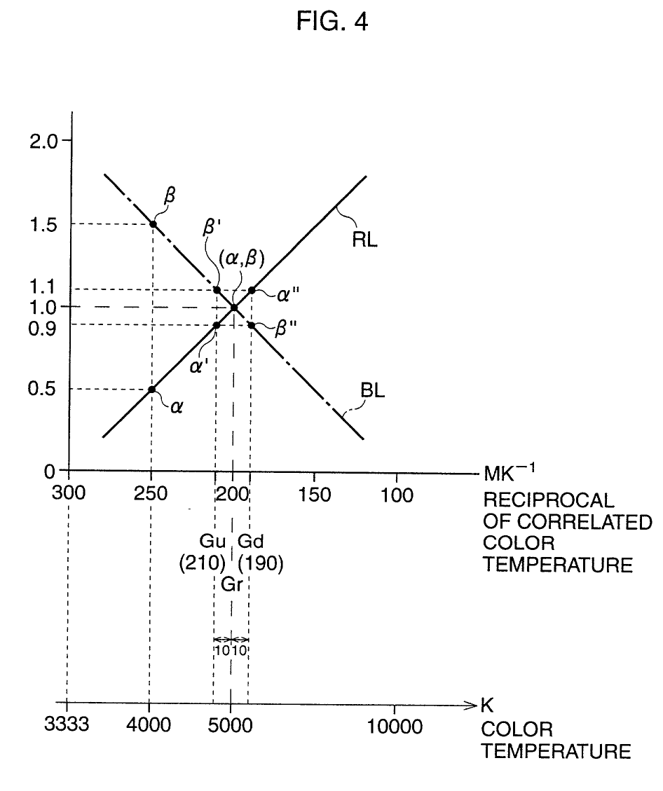

FIG. 4 is a view showing a graph which indicates a color temperature represented by the reciprocal of correlated color temperature and the R-gain and B-gain coefficients α, β, α′, β′, α″, β″.

The vertical axis indicates values of the R-gain and B-gain coefficients and the horizontal axis indicates the magnitude of the reciprocal of the correlated color temperature. Note that, the magnitude of the reciprocal of correlated color temperature increases along the left direction. The value of the R-gain coefficient α corresponding to the standard color temperature Gr is shown by a solid line RL, and the value of the B-gain coefficient β corresponding to the standard color temperature Gr is shown by a single-chained line BL. Hereinafter the values of the R-gain and B-gain coefficients α, β, corresponding to the standard color temperature Gr, are represented by a standard R-gain coefficient α and a standard B-gain coefficient β, respectively.

As is well known, when a value of a color temperature is large, namely, the reciprocal of the correlated color temperature is small, light radiating from the illuminating-light and reflected on the object, includes a great quantity of light of the red color wave range. Inversely, when the value of the color temperature is small, namely, the reciprocal of the collated color temperature is large, light radiating from the illuminating-light includes a great quantity of light of the blue color wave range. Therefore, as shown by the solid line RL and the single-chained line BL, the value of the standard R-gain coefficient a proportionally increases as the reciprocal of the correlated color temperature corresponding to the standard color temperature Gr decreases, whereas the value of the standard B-gain coefficient β proportionally decreases as the reciprocal of the correlated color temperature corresponding to the standard color temperature Gr decreases.

When the photographing mode is not the “WB bracketing mode”, the white balance adjustment is performed in accordance with the standard R-gain and B-gain coefficients α, β. For example, when the standard color temperature, detected or set, is 4000 (K), in other words, the reciprocal of the correlated color temperature is 250 (MK⁻¹), the R-gain and G-gain coefficients α, β are determined to “0.5” and “1.5” respectively, which satisfy the above formula (1).

On the other hand, when the “WB bracketing mode” is selected, the standard R-gain and B-gain coefficients are determined in accordance with the solid line RL and the single-chained line BL. Further, the first and second shifted color temperatures Gu, Gd are defined and R-gain and B-gain coefficients corresponding to the first and second shifted color temperatures Gu, Gd are defined by utilizing the relationship between the standard color temperature Gr and the standard R-gain and B-gain coefficients, namely, the solid line RL and the single-chained line BL.

For example, the standard color temperature Gr represented by the reciprocal of the collated color temperature is set to 200MK⁻ (=5000K), the standard R-gain and B-gain coefficients α, β become “1.0” and “1.0” respectively. As described above, in this embodiment, an value-interval between the standard color temperature Gr and the first and second shifted color temperatures Gu, Gd are determined to +/−10 (MK⁻¹), therefore, the first and second shifted color temperatures Gu, Gd are set to 210MK⁻¹ and 190 MK⁻¹ respectively. In this case, the R-gain and B-gain coefficients α′, β′, corresponding to the first shifted color temperature Gu (=210MK⁻¹), become “0.9” and “1.1” respectively. Consequently, the second frame image becomes an image, in which the blue color is more emphasized when compared to the first frame image. On the other hand, the gain coefficients α″, β″, corresponding to the second shifted color temperature Gd (=190MK⁻¹), become “1.1” and “0.9” respectively. Consequently, the third frame image becomes an image, in which red color is more emphasized compared to the first frame image.

As described above, while the “AWB mode” is selected, the standard color temperature Gr is set to a value detected by the color temperature sensor 120, whereas, when the “MSWB mode” is selected, the standard color temperature Gr is set by the operator. A table T1 shown below is a table indicating the standard color temperature Gr, the first shifted color temperature Gu and the second shifted color temperature Gd at the “AWB mode” and the “MSWB mode”.

TABLE T1

| | S.C.T. | F.S.C.T. | S.S.C.T. |
|---|---|---|---|
| I.L. | Gr (MK⁻¹) | Gu (MK⁻¹) | Gd (MK⁻¹) |
| MSWB | | | |
| D.L. | gₘ₁ | gₘ₁ + 10 | gₘ₁ − 10 |
| | (=154) | (=164) | (=144) |
| I.L. | gₘ₂ | gₘ₂ + 10 | gₘ₂ − 10 |
| | (=350) | (=360) | (=340) |
| F.L. | gₘ₃ | gₘ₃ + 10 | gₘ₃ − 10 |
| | (=111) | (=121) | (=101) |
| C.L. | gₘ₄ | gₘ₄ + 10 | gₘ₄ − 10 |
| | (=200˜250) | (=210˜260) | (=190˜240) |
| AWB | Gr | Gr + 10 | Gr − 10 |

When performing the MSWB mode, the standard color temperature Gr, represented by the reciprocal of correlated color temperature, is set to one of gₘ₁, gₘ₂, gₘ₃ gₘ₄, which correspond to day-light, incandescent light, fluorescent light and cloudy-light respectively. As described above, the values of gₘ₁, gₘ₂, gₘ₃, gₘ₄ are stored in the memory in advance. When performing the AWB mode, the standard color temperature Gr is determined in accordance with a color temperature detected by the color temperature sensor 120.

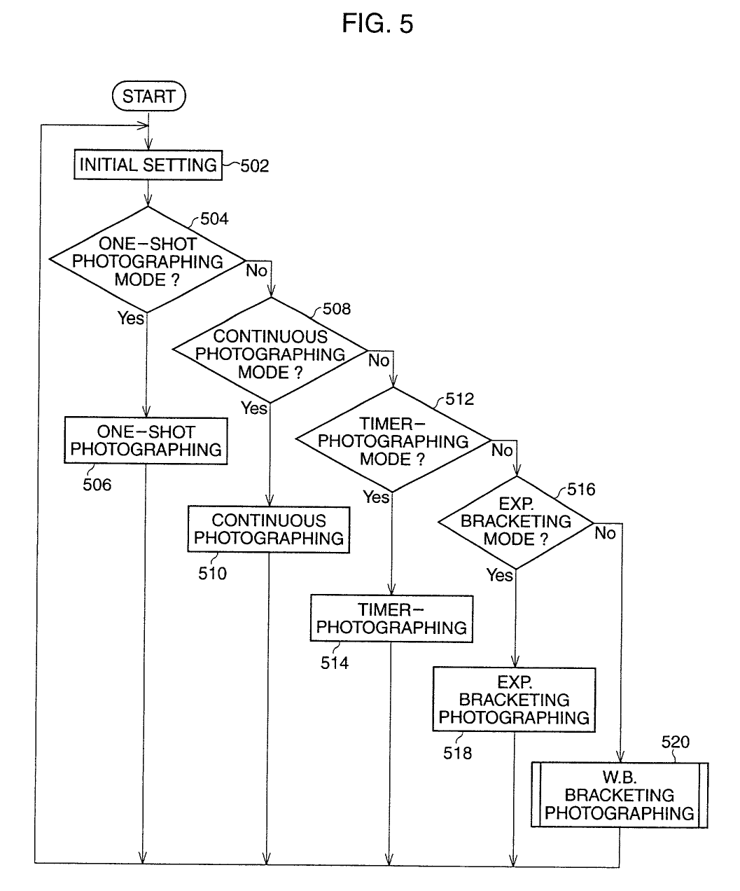

FIG. 5 is a flowchart showing a photographing process performed by the system control circuit 200. When the power button 107 is depressed, the photographing process is started.

In Step 502, an initial setting, such as setting of an the aperture 114, is performed. In Step 504, it is determined whether the photographing mode is set to the “one-shot photographing mode”, namely, the index 150 of the mode-selection dial 150 is aligned with the mark 150A. When it is determined that the photographing mode is set to the “one-shot photographing mode”, the process goes to Step 506, wherein one frame worth is photographed. On the other hand, when it is determined that the photographing mode is not set to the “one-shot photographing mode ”, the process goes to Step 508.

In Step 508, it is determined whether the photographing mode is set to the “continuous photographing mode”, namely, the index 150E of the mode-selection dial 150 is aligned with the mark 150B. When it is determined that the photographing mode is set to the “continuous photographing mode”, the process goes to Step 510, wherein continuous photographing is performed. On the other hand, when it is determined that the photographing mode is not set to the “continuous photographing mode”, the process goes to Step 512.

In Step 512, it is determined whether the photographing mode is set to the “timer-photographing mode”, namely, the index 150 E of the mode-selection dial 150 is aligned with the mark 150C. When it is determined that the photographing mode is set to the “timer-photographing mode”, the process goes to Step 512, wherein photographing with the timer-function is performed. On the other hand, when it is determined that the photographing mode is not set to the “timer-photographing mode”, the process goes to Step 516.

In Step 516, it is determined whether the photographing mode is set to the “EXP bracketing mode”, namely, the index 150E of the mode-selection dial 150 is aligned with the WB/WXP bracketing selecting-lever 160, and the WB/EXP bracketing selecting-lever 160 is set to the “EXP bracketing mode”. When it is determined that the “EXP bracketing mode” is set, the process goes to Step 518, wherein the auto-bracketing photography with respect to the exposure, is performed. On the other hand, when it is determined that the photographing mode is not set to the “EXP bracketing mode” but set to the “WB bracketing mode” by the WB/EXP bracketing selecting-lever 160, the process goes to Step 520. In Step 520, as described later, auto-bracketing photographing with respect to the white balance is performed. When one of Steps 506, 510, 514, 518 and 520 is performed, the process returns to Step 502.

The photographing process is repeatedly performed until the power button 170 is further depressed and power switch 308 is turned OFF. Note that, each photographing method performed at Step 506, 510, 514, 518 are well known in the prior art.

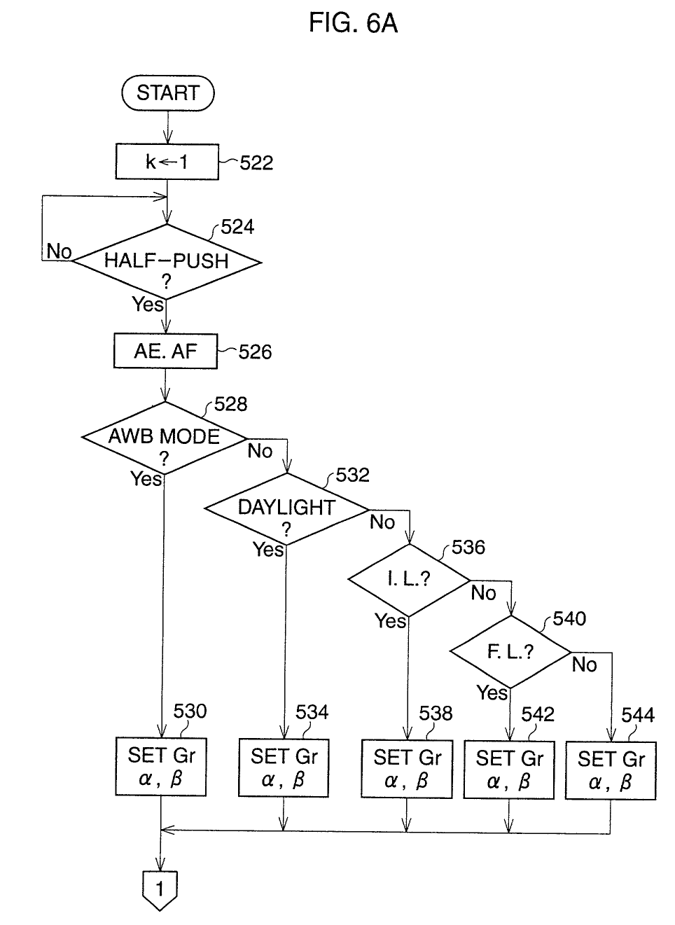

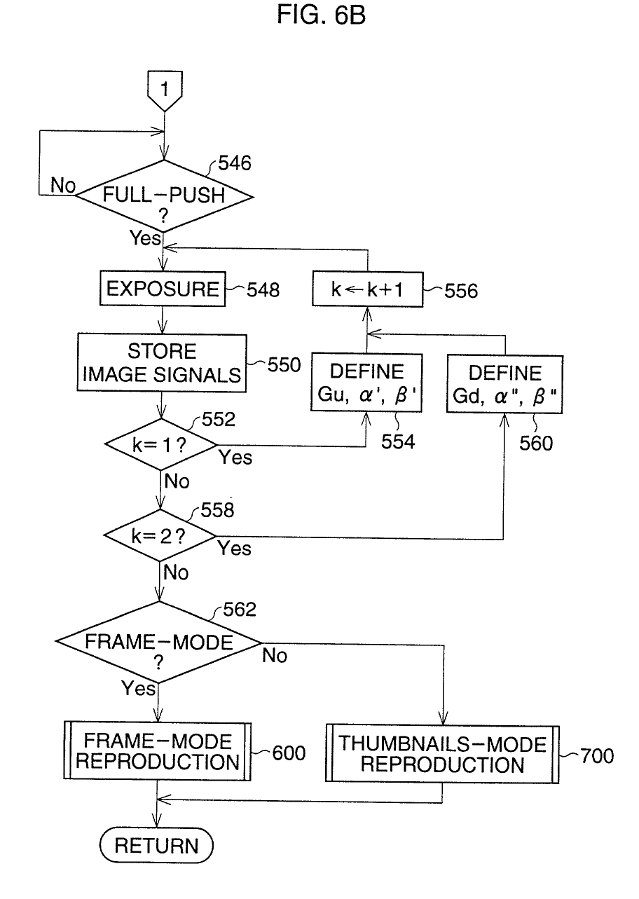

FIGS. 6A and 6B are views showing a subroutine of Step 520 in FIG. 5.

In Step 522, a counter variable “k”, indicating the photographing times or capture times, is set to “1”. In Step 524, it is determined whether the release button 140 is halfway depressed, namely, the half-push switch 302 is turned ON. When it is determined that the release button 140 is not depressed halfway, Step 524 is repeatedly performed. On the other hand, when it is determined that the release button 140 is halfway depressed, the process goes to Step 526.

In Step 526, the AE (Auto-Exposure) process and the AF (Auto-Focus) process are performed, namely, the exposure value is automatically determined and the object image is automatically focused onto the CCD 116.

In Step 528, it is determined whether the “AWB mode” is selected by operation of the cross button 134. When it is determined that the AWB is selected, the process goes to Step 530, wherein the white balance adjustment is performed, namely, the standard color temperature Gr is detected by the color temperature sensor 120. Further, the values of the standard R-gain and B-gain coefficients α, β are defined on the basis of the graph shown in FIG. 4. On the other hand, when it is determined that the AWB adjustment is canceled, namely, MSWB adjustment is selected by the cross button 134, the process goes to Step 532.

In Step 532, it is determined whether the standard color temperature Gr is set to “gₘ₁” (See in the Table T1), which corresponds to the “day-light”, by the operator. When it is determined that the standard color temperature Gr is set to “gₘ₁”, the process goes to Step 534, wherein the standard R-gain and B-gain coefficients α, β, corresponding to the color temperature “gₘ₁”, are defined on the basis of the graph. On the other hand, when it is determined that the standard color temperature Gr is not set to “gₘ₁”, the process goes to Step 536.

In Step 536, it is determined whether the standard color temperature Gr is set to “gₘ₂”, which corresponds to “incandescent light”, by the operator. When it is determined that the standard color temperature Gr is set to “gₘ₂”, the process goes to Step 538, wherein the standard R-gain and B-gain coefficients α, β, corresponding to the color temperature “gₘ₂”, are defined on the basis of the graph. On the other hand, when it is determined that the standard color temperature Gr is not set to “gₘ₂”, the process goes to Step 540.

In Step 540, it is determined whether the standard color temperature Gr is set to “gₘ₃”, which corresponds to “fluorescent light”, by the operator. When it is determined that the standard color temperature Gr is set to “gₘ₃”, the process goes to Step 542, wherein the standard R-gain and B-gain coefficients α, β, corresponding to the color temperature “gₘ₃”, are defined on the basis of the graph. On the other hand, when it is determined that the standard color temperature Gr is not set to “gₘ₃”, namely, the standard color temperature Gr is set to “gₘ₄”, corresponding to “cloudy light”, the process goes to Step 544, wherein the standard R-gain and B-gain coefficients α, β, corresponding to the color temperature “gₘ₄”, are defined on the basis of the graph.

After the standard R-gain and B-gain coefficients α, β are defined in one of Steps 530, 534, 538, 542, 544, the process goes to Step 546 shown in FIG. 6B.

In Step 546, it is determined whether the release button 140 is fully depressed, namely, the full-push switch 304 is turned ON. When it is determined that the release button 140 is not fully depressed, Step 546 is continuously repeated. On the other hand, when it is determined that the release button 140 is fully depressed, the process goes to Step 548.

In Step 548, the photographing is performed. Namely, the CCD 116 is exposed for a given interval in accordance with the shutter speed, the image-pixels signals are read from the CCD 116 and the separated R, G, B color signal components are subjected to various process, including the white balance adjustment based on the standard color temperature Gr. Then, in Step 550, the digital image signals are temporarily stored in the buffer memory 226. After Step 550 is performed, the process goes to Step 552.

In Step 552, it is determined whether the counter variable k is “1”. When it is determined that the counter variable k is “1”, the process goes to Step 554, wherein the R-gain and B-gain coefficients α′, β″, corresponding to the first shifted color temperature Gu, are defined on the basis of the graph shown in FIG. 4. As described above, the first shifted color temperature Gu is shifted from the standard color temperature Gr by 10 (MK⁻¹).

In Step 556, the counter variable k is incremented by 1, and the second photographing is performed at Step 548. Then, the image-pixel signals are read from the CCD 116 and the R, G, B color signal components are subjected to the white balance adjustment in accordance with the first shifted color temperature Gu. In Step 550, the digital image signals corresponding to the second frame are stored in the buffer memory 226. When it is determined that the counter variable k is not “1” at Step 552, the process goes to Step 558.

In Step 558, it is determined whether the counter variable k is “2”. When it is determined that the counter variable k is “2”, the process goes to Step 560. In Step 560, the second shifted color temperature Gd, which is shifted from the standard color temperature Gr by 10 (MK⁻¹), is defined and the gain coefficients α″, β″ corresponding to the second shifted color temperature Gd are defined. In Step 556, the counter variable k is incremented by 1.

Then, the photographing for the third frame is performed at Step 548. The image-pixel signals are read from the CCD 116 and the R, G, B color signal components are subjected to the white balance adjustment in accordance with the second shifted color temperature Gd. Then, the digital color image signals corresponding to the third frame are stored in the buffer memory 226. After the three frames are obtained, each of which has a different relative color balance, the process goes to Step 562.

In Step 562, it is determined whether the image reproduction mode is set to the, “frame-mode”, namely, the image reproduction switch 312 is turned ON by depressing image-reproduction mode button 170. When it is determined that the image reproduction mode is set to the “frame-mode”, the process goes to Step 600, wherein the three frames of the object images are displayed on the LCD monitor 130 frame by frame. On the other hand, when it is determined that the image reproduction mode is not set to the “frame-mode”, namely, set to “thumbnails-mode”, the process goes to Step 700, wherein the three frames are displayed on the LCD 130 simultaneously.

When Step 600 or Step 700 is performed, the WB bracketing photographing (performed at Step 520) is terminated, and the process returns to Step 502.

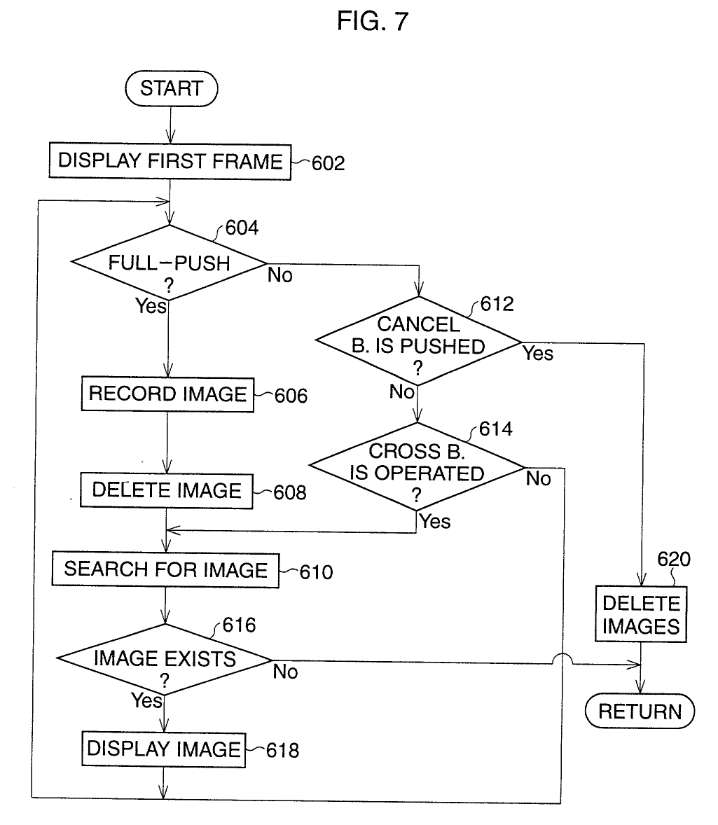

FIG. 7 is a view showing a subroutine of Step 600 shown in FIG. 6B.

In Step 602, the digital image signals of the first frame are read from the buffer memory 226, and the object image of the first frame is displayed on the total area of the LCD monitor 130. In Step 604, it is determined whether the release button 140 is fully depressed by the operator, namely, the full-push switch 304 is turned ON. When it is determined that the release button 140 is fully depressed, the process goes to Step 606, wherein the digital image signals corresponding to the displayed object image are subjected to the compression process and then recorded in the memory card 300 as image data. Further, at Step 608, the displayed object image is deleted from the LCD monitor 130. After Step 608 is performed, the process goes to Step 610. On the other hand, when it is determined that the release button 140 is not fully depressed at Step 604, the process goes to Step 612.

In Step 612, it is determined whether the cancel button 136 is depressed. When it is determined that the cancel button 136 is not depressed, the process goes to Step 614, wherein it is determined whether the cross button 134 is operated to select another frame image among the three frames. When it is determined that the cross button 134 is not operated, the process returns to Step 604. On the other hand, when it is determined that the cross button 134 is operated, the process goes to Step 610.

In Step 610, the object image is detected among the three frame worth of the digital color image signals stored in the buffer memory 226 in accordance with Step 606 or Step 614. When the object image is recorded in the memory card 300 at Step 606 and the process goes from Step 606 to Step 610, another frame, or the remaining frame, is detected. On the other hand, when the process goes from Step 612 to Step 610, a frame selected by the cross button 134 is searched for in the buffer memory 226.

In Step 616, it is determined whether the object image to be displayed on the LCD monitor 130 exists in the buffer memory 226. When it is determined that the object image to be displayed on the LCD monitor 130 does not exist in the buffer memory 226, namely, all of the object images are recorded in the memory card 300 or the object image selected by the cross button 134 does not exist, the “frame-mode” is terminated. On the other hand, when the object image to be displayed on the LCD monitor 130 exists, the process goes to Step 618, wherein the object image found at Step 610 is displayed on the LCD monitor 130. After Step 618 is performed, the process returns to Step 604.

On the other hand, when it is determined that the cancel button 136 is depressed at Step 612, the process goes to Step 620, wherein the three frames of the digital image signals stored in the buffer memory 226 are deleted. The “frame-mode” is then terminated.

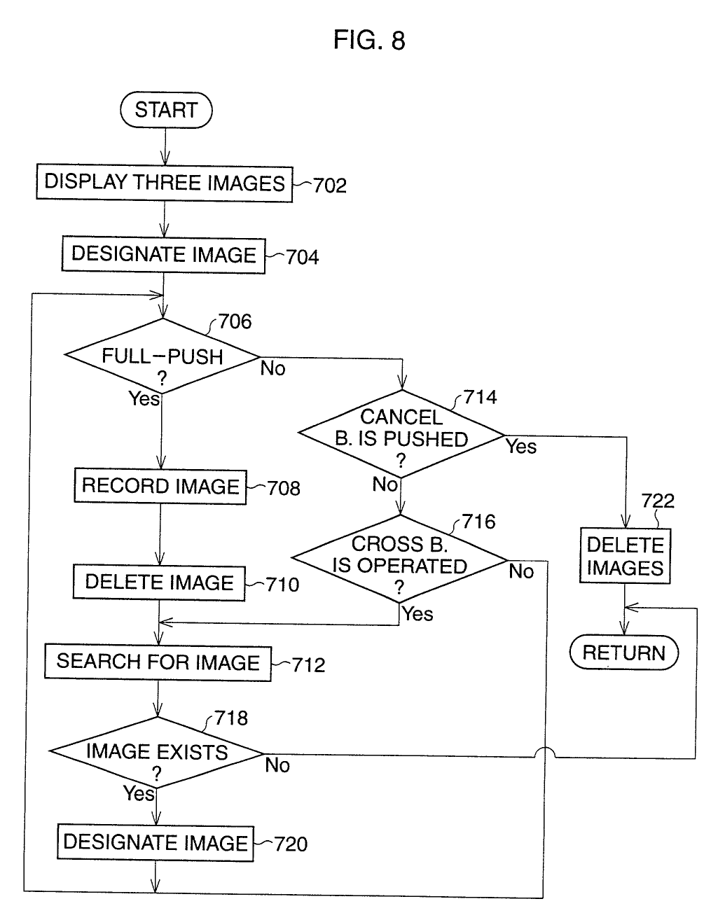

FIG. 8 is a view showing a subroutine of the multiple image reproduction process, performed at Step 700 in FIG. 6B.

In Step 702, three frames worth of digital image signals are read from the buffer memory 226 and three images, so called “thumbnail images”, are displayed on the LCD monitor 130. In Step 704, the first frame image from the thumbnail images is designated. Herein, the first frame image is framed by a blinking colored line. In Step 706, it is determined whether the release button 140 is fully depressed. When it is determined that the release button 140 is fully depressed, the process goes to Step 708, wherein the designated image is recorded in the memory card 300. Then, in Step 710, the recorded image is deleted from the buffer memory 226 and the LCD monitor 130. After Step 710 is performed, the process goes to Step 712.

On the other hand, when it is determined that the release button 140 is not fully depressed, the process goes to Step 714. Steps 714 and 716 correspond to Steps 612 and 614 shown in FIG. 7, respectively. After Step 716 is performed, the process goes to Step 712.

Steps 712 and 718 correspond to Steps 610 and 616 respectively. After Step 718 is performed, the process goes to Step 720. In Step 720, another image among the thumbnail images is selected. After Step 720 is performed, the process returns to Step 706.

On the other hand, when it is determined that the cancel button 136 is depressed at Step 714, the process goes to Step 722. Step 722 corresponds to Step 620 shown in FIG. 7. After Step 722 is performed, the process is terminated.

In this way, in this embodiment, when the “WB bracketing mode” is selected, three frames worth of still images are consecutively captured. At this time, in the image processing circuit 224, the color image signals corresponding to the first frame are subjected to the white balance adjustment in accordance with the standard color temperature Gr and the standard R-gain and B-gain coefficients α, β. Similarly, the color image signals corresponding to the second frame are subjected to the white balance adjustment in accordance with the first shifted color temperature Gu and the R-gain and B-gain coefficients α′, β′ and the color image signals corresponding to the third frame are subjected to the white balance adjustment in accordance with the second shifted color temperature Gd and the R-gain and B-gain coefficients α″, β″. Consequently, the color (color balance) in each of the captured images (three frames worth of digital image signals) is different.

Further, the captured images are displayed on the LCD 130 in accordance with the “frame-mode” or the “thumbnails-mode”. Thus, the operator can selectively record a preferred image in the memory card 300. When the “frame-mode” is selected, the operator can confirm the color in the displayed image in detail, on the other hand, when the “thumbnails-mode” is selected, the operator can compare the color of the three images against each other.

The value-interval between the standard color temperature Gr and the first and second shifted color temperature Gu, Gd may be one of range 5 to 100 (MK⁻¹) in place of 10 (MK⁻¹). Further, a selector for changing the value-interval may be provided on the digital still camera 100.

In this embodiment, three frame images are captured when the “WB bracketing mode” is selected. The capture number is not restricted to three. For example, five frame images may be captured. In this case, a standard color temperature and four shifted color temperatures are defined such that the value-interval between them becomes a constant interval.

The standard color temperature and the shifted color temperatures may be defined without using the linear relationship shown in FIG. 4. In this case, when a shifted color temperature is larger than the standard color temperature, values of the R-gain and B-gain coefficients may be defined as a larger value and a smaller value respectively, compared to the standard-values corresponding to the standard color temperature Gr. Thus, the red color in the recorded image is emphasized compared to the image corresponding to the standard color temperature Gr. Whereas, when a shifted color temperature is smaller than the standard color temperature, values of the R-gain and B-gain coefficients are defined as a smaller value and a larger value respectively, compared to the standard-values corresponding to the standard color temperature Gr. Thus, the blue color is emphasized.

In this embodiment, the operator selects an image to be recorded in the memory card 300, however, All of the three frame images may be recorded in the memory card 300 in place of the image-display process.

When the “AWB mode” is selected, the standard color temperature Gr may be detected on the basis of the image-pixel signals read from the CCD 116 in place of the color temperature sensor 120.

Finally, it will be understood by those skilled in the art that the foregoing description is of preferred embodiments of the device, and that various changes and modifications may be made to the present invention without departing from the spirit and scope thereof.

The present disclosure relates to subject matters contained in Japanese Patent Application No. 2000-071776 (filed on Mar. 15, 2000) which is expressly incorporated herein, by reference, in its entirety.

1. A digital still camera with an image sensor comprising:
an exposure controller that exposes said image sensor such that a series of still images is consecutively captured, a series of one frame worth of image-pixel signals, corresponding to the series of still images, being read from said image sensor in order;
a signal processor that generates a series of one frame worth of color image signals in accordance with the series of one frame worth of image-pixel signals, each divided into a red color signal component, a green color signal component and a blue color signal component;
a color temperature setter that defines a standard color temperature corresponding to illuminating-light, and defines at least one shifted color temperature, which is different relative to said standard color temperature by a given amount;
a color balance adjuster that adjusts a relative color balance with respect to the red, green and blue color signal components in each of the series of one frame worth of color image signals, in accordance with said standard color temperature and said at least one shifted color temperature; and
a recording processor that records at least one of the series of one frame worth of color image signals, adjusted with respect to the relative color balance, in a recording medium detachably installed in said digital still camera,
wherein said color balance adjuster adjusts the relative color balance, by changing the color temperature in each of the series of one frame worth of color image signals.

2. The digital still camera of claim 1, further comprising:
a color temperature sensor that detects a color temperature of said illuminating-light,
wherein said color temperature setter defines a color temperature detected by said color temperature sensor as said standard color temperature.

3. The digital still camera of claim 1, further comprising:
a color temperature memory, in which a plurality of color temperatures are stored as data; and
a color temperature selector for selecting one color temperature from the plurality of color temperatures, said color temperature selector being operated by an operator,
wherein said color temperature setter defines a color temperature selected by said color temperature selector as said standard color temperature.

4. The digital still camera of claim 1, wherein said color balance adjuster adjusts a gain to said red color signal component and a gain to said blue color signal component, by multiplying a R-gain coefficient of said red color signal component and a B-gain coefficient of said blue color signal component by said red color signal component and said blue color signal component, respectively,
wherein said color temperature setter defines a red standard-value of the R-gain coefficient and a blue standard-value of the B-gain coefficient, corresponding to said standard color temperature, such that a ratio of said red, green and blue color signal components generally become “1:1:1” with a white-object, and
wherein said color temperature setter defines a value of the R-gain coefficient and a value of the B-gain coefficient, corresponding to said at least one shifted color temperature, to one of a smaller value and a larger value respectively, compared to said red standard-value and said blue standard-value, and a larger value and smaller value respectively, compared to said red standard-value and said blue standard-value.

5. The digital still camera of claim 4, wherein said standard color temperature and said at least shifted color temperature are represented by a reciprocal of correlated color temperature,
wherein said color temperature setter defines the R-gain and B-gain coefficients corresponding to said standard color temperature in accordance with a relationship between said standard color temperature and said red and blue standard-values of the R-gain and B-gain coefficients, and
wherein said color balance adjuster defines values of the R-gain and B-gain coefficients, corresponding to said at least one shifted color temperature, by utilizing said relationship.

6. The digital still camera of claim 5, wherein said color temperature setter defines at least two shifted color temperatures, such that a value-interval between a color temperature and adjacent color temperature, among said standard color temperature and said at least two shifted color temperatures, becomes a generally constant interval.

7. The digital still camera of claim 6, wherein said color temperature setter defines a first shifted color temperature and a second shifted color temperature, said first shifted color temperature being larger than said standard color temperature by a given shifting-amount, the second shifted color temperature being smaller than said standard color temperature by said given shifting-amount.

8. The digital still camera of claim 1, further comprising:
an image-memory for temporarily storing the series of one frame worth of color image signals, adjusted with respect to the relative color balance,
wherein said recording processor selectively records at least one of the series of one frame worth of color image signals, stored in said image-memory, in said recording medium.

9. The digital still camera of claim 1, further comprising:
an image-memory that temporarily stores the series of one frame worth of color image signals, adjusted with respect to the relative color balance, respectively; and
a display processor that displays a series of reproduced still images, which are reproduced from the series of one frame worth of color image signals stored in said image-memory, on a display provided on said digital still camera; and
an image selector for selecting at least one image to be recorded from the series of reproduced still images, said image selector being operated by an operator;
wherein said recording processor selectively records at least one frame worth of color image signals, corresponding to a reproduced image selected by said image selector, in said recording medium.

10. The digital still camera of claim 9, wherein said display processor selectively displays one reproduced image from the series of reproduced still images on said display.

11. The digital still camera of claim 9, wherein said display processor displays all of the series of reproduced still images on said display simultaneously.

12. A white balance adjustment apparatus incorporated in a digital still camera with an image sensor, a series of one frame worth of color image signals being generated on the basis of a series of one frame worth of image-pixel signals read from said image sensor in order, said white balance adjustment apparatus comprising:
a color temperature setter that defines a standard color temperature corresponding to illuminating-light, and defines at least one shifted color temperature, which is different relative to said standard color temperature by a given amount; and
a color balance adjuster that adjusts a relative color balance with respect to red, green and blue color signal components in each of the series of one frame worth of color image signals, in accordance with said standard color temperature and said at least one shifted color temperature;
wherein said color balance adjuster adjusts the relative color balance, by changing the color temperature in each of the series of one frame worth of color image signals.
